(19) United States
(12) Patent Application Publication
(10) Pub. No.: US 2010/0104152 A1
(43) Pub. Date: Apr. 29, 2010

(54) AUTOMATIC VASCULAR TREE LABELING

(76) Inventors: Elie ABDELNOUR, Buc (FR); Laurent Launay, Saint Remy Les Chevreuse (FR); Eric Pichon, Paris (FR); Céline Pruvot, Buc (FR)

Correspondence Address: General Electric Company;GE Global Patent Operation, 2 Corporate Drive, Suite 648, Shelton, CT, 06484, US

(21) Appl. No.: 12/565,068

(22) Filed: Sep. 23, 2009

(30) Foreign Application Priority Data
Sep. 24, 2008 (FR) 0856424

(51) Int. Cl. G06K 9/62

(52) U.S. Cl. 382/128

(57) ABSTRACT

A method to label a vascular tree from an image of an organ or group of organs that is acquired by a medical imaging device. The method includes generating at least one vascular tree model of a determined organ including a database of labels corresponding to each branch of the vascular tree models. The method also includes determining an acquired vascular tree of the organ or group of organs by segmenting the previously acquired image. The method also includes comparing the acquired vascular tree with the vascular tree model(s) of said organ or group of organs. The method also includes displaying the acquired vascular tree and the labels corresponding to the vascular tree model having the closest similarity with the acquired vascular tree.

### CROSS-REFERENCE TO RELATED APPLICATIONS

This application claims priority under 35 U.S.C. §119(a)-(d) or (f) to prior-filed, co-pending French patent application, Serial No. 0856424, filed on Sep. 24, 2008, which is incorporated by reference herein in its entirety.

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### REFERENCE TO A SEQUENCE LISTING, A TABLE, OR COMPUTER PROGRAM LISTING APPENDIX SUBMITTED ON COMPACT DISK

Not Applicable

### BACKGROUND OF THE INVENTION

1. Field of the Invention

The field of the invention concerns the general area of methods and devices to analyze and display vascular trees, and more particularly a method and device to label a vascular tree from an image of an organ or group of organs that is acquired using a medical imaging device.

2. Discussion of Related Art

In the area of medicine, it is well known to identify and label the different branches of a vascular tree for diagnostic purposes, or to prepare for surgery.

The identification and labelling of the different branches of a vascular tree using Computed Tomography (CT) images, is a mere material operation which takes up precious time that would be preferably used for the analysis and diagnosis of blood vessels.

The most widely used method to analyze and label a vascular tree consists of manually positioning a point on an image at the free end of each vascular branch using a computer provided with display means and a pointer device such as a mouse, keypad or similar. After positioning the points at the free ends of said branches, the computer runs a program which displays the different vascular branches for diagnosis purposes. Different views are taken, usually a 3D view, an axial view and an oblique view.

This manual procedure is particularly time-consuming, especially for a user with little training In addition, this type of procedure does not provide optimum results since with manual positioning it is difficult to position the points accurately at the free ends of the vascular branches. The vascular branches are therefore incompletely displayed by the computer.

To overcome these disadvantages, different methods and apparatus have already been imagined to select and label vascular branches more swiftly and efficiently.

Such is the case for example in patent application US 2006/0122501 which describes a method and apparatus to select and/or label vascular branches. The method consists of locating a starting point on a main vessel in a medical image obtained by a medical imaging device, the bones being removed from the image, then of identifying the bifurcation points and branch starting points on the main vessel, followed by construction of an adjacent graph of each branch leaving the main vessel, the final step consisting of selecting and displaying the most favourable pathway through the vessels, or of labelling and displaying the branches of the main vessel.

Automatic labelling methods are also known for vascular trees, described in particular in the publication IEEE transactions and medical imaging, volume 17, no 3, June 1998: “Model-Guided Labelling of Coronary Structure” Norberto Ezquerra, Steve Capell, Larry Klein, and Pieter Duijves. The method consists of determining a first symbolic model with an acyclic graph giving the vascular tree hierarchy and inter-relationships between the different branches, and of determining a general 3D model which captures spatial and geometric relationships between the branches. The method uses an algorithm to take into account information derived from temporal sequence frames of images transmitted by a medical imaging device.

Although these methods have significantly improved the selection and/or labelling of vascular branches, they are usually dedicated to a specific part of the human body such as the cerebral vascular tree, the heart vascular tree etc. and do not enable a user to adapt labelling in relation to one's own image interpretation.

There is therefore a need for a method and apparatus to label the vascular tree of any organ or group of organs, which can be adapted by a user in relation to the interpretation of images acquired by the medical imaging device.

One of the purposes of the invention is therefore to overcome these drawbacks by proposing a new device for labelling the vascular tree of an organ or group of organs from images acquired by a medical imaging device.

### BRIEF SUMMARY OF THE INVENTION

In one embodiment, a method of labeling a vascular tree from an image of an organ or group of organs acquired by a medical imaging device is provided. The method is significant in that it comprises at least the following steps of:

generating at least one vascular tree model of a determined organ including a database of labels corresponding to each branch of the vascular tree models,

determining a vascular tree called an acquired tree of the organ or group of organs by segmenting the previously acquired image, and comparing the acquired vascular tree with the vascular tree model or models of the said organ or group of organs, and

displaying the acquired vascular tree and the labels corresponding to the vascular tree model having the greatest similarity with the acquired vascular tree.

In particularly advantageous manner, the method also comprises the following steps:

receiving input from an operator that modifies at least one displayed label,

determining the other displayed labels in relation to the modified label(s) of the vascular tree model, and

displaying the acquired tree and of the corresponding labels thus determined.

Also, the preceding steps of modification by an operator of at least one displayed label, of determining the other displayed labels in relation to the modified label or labels of the vascular tree model, and of displaying the acquired tree and labels thus determined, are repeated until the displayed vascular tree conforms to operator requirements.

Preferably, the displayed vascular tree and the corresponding labels are recorded in a model database, after an optional learning step of neural network type.

Another embodiment concerns a vascular tree labelling device which controls a medical imaging device. Said device is significant in that it comprises a computer provided with storage means in which a database is stored containing vascular tree models of a determined organ, including a database of labels corresponding to each branch of the tree models, said computer being configured to determine an acquired vascular tree of the organ or group of organs by segmenting an image of the organ or group of organs previously acquired by the medical imaging device, then to compare the acquired vascular tree with the vascular tree model(s) of said organ or group of organs, and finally to display the acquired vascular tree and the labels corresponding to the modelled vascular tree having the closest similarity with the acquired vascular tree.

Said computer is advantageously configured to enable an operator modify at least one of the displayed labels, then to determine the other displayed labels in relation to the modified label(s) and modelled vascular tree, and finally to display the acquired tree and the corresponding labels thus determined.

Additionally, the computer is configured so that the preceding steps of modification by an operator of at least one displayed label, determination of the other displayed labels in relation to the modified label(s) and modelled vascular tree, and display of the acquired tree and corresponding labels thus determined, can be repeated until the displayed vascular tree conforms to operator requirements.

Also, the device of the invention comprises a recording device to record the displayed vascular tree and the corresponding labels in a database of models, and further comprises a learning device of neural network type.

Another embodiment concerns a computer program recorded on a physical medium and comprising instructions which can be read and transmitted to a processor so that it can execute the following instructions of:

generating at least one vascular tree model of a determined organ including a database of labels corresponding to each branch of the vascular tree models,

determining an acquired vascular tree of the organ or group of organs by segmenting the previously acquired image,

comparing the acquired vascular tree with the vascular tree model(s) of said organ or group of organs,

displaying the acquired vascular tree and the labels corresponding to the modelled vascular tree having the closest similarity with the acquired vascular tree.

Said program advantageously comprises at least the following instructions:

receiving input from an operator that modifies at least one displayed label,

determining the other displayed labels in relation to the modified label(s) and modelled vascular tree, and

displaying of the acquired tree and of the corresponding labels thus determined.

In addition, the computer program comprises instructions to repeat the preceding steps of modification by an operator of at least one displayed label, determination of the other displayed labels in relation to the modified label(s) and modelled vascular tree, and display of the acquired tree and corresponding labels thus determined, until the displayed vascular tree conforms to operator requirements.

In addition, the computer program comprises an instruction to record displayed vascular tree models and corresponding labels in a database, and a learning instruction of neural network type.

Finally, a last subject of the invention concerns a physical medium, which may or may not be removable, which can be read by a machine and on which all or part of the instructions of said computer program are recorded.

### BRIEF DESCRIPTION OF THE SEVERAL VIEWS OF THE DRAWINGS

Other advantages and characteristics will become better apparent from the following description of the variant of embodiment given as a non-limiting example of the method and device for labelling a vascular tree in accordance with the invention, with reference to the appended drawings in which:

FIG. 1 is a perspective view of a system to acquire CT images;

FIG. 2 is layout diagram of an acquired image processing system using the CT acquisition system in FIG. 1;

FIG. 3 is a flow chart of the method to label a vascular tree conforming to the invention; and

FIG. 4 is a graphic illustration of a vascular tree obtained using the method of the invention.

### DETAILED DESCRIPTION OF THE INVENTION

A description is given below of the method to label a vascular tree using an image of an organ or group of organs acquired via a computed tomography image acquisition system (CT); nonetheless the CT image acquisition system could be substituted by any image acquisition system such as ultrasound imaging, nuclear magnetic resonance imaging (MRI), imaging by single photon emission CT (SPECT), or an image acquisition system using positron emission computed tomography (PET-CT).

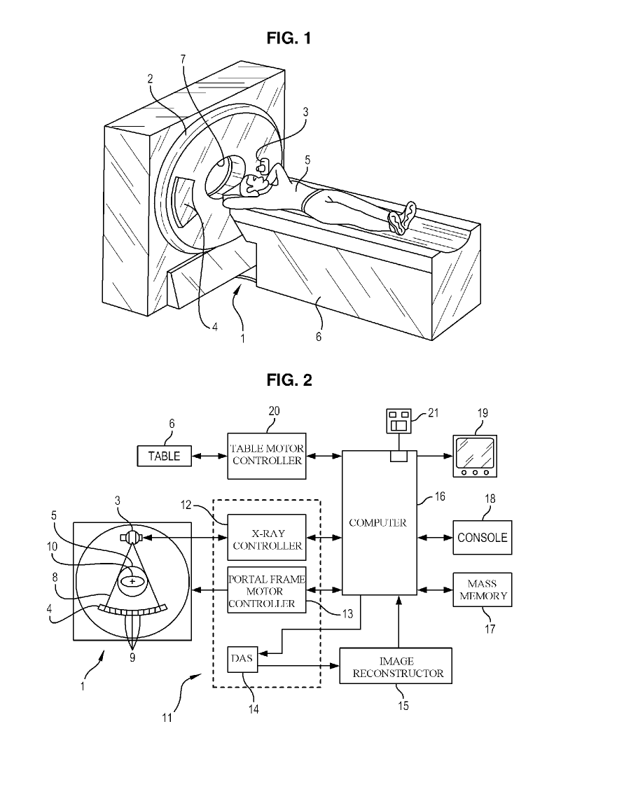

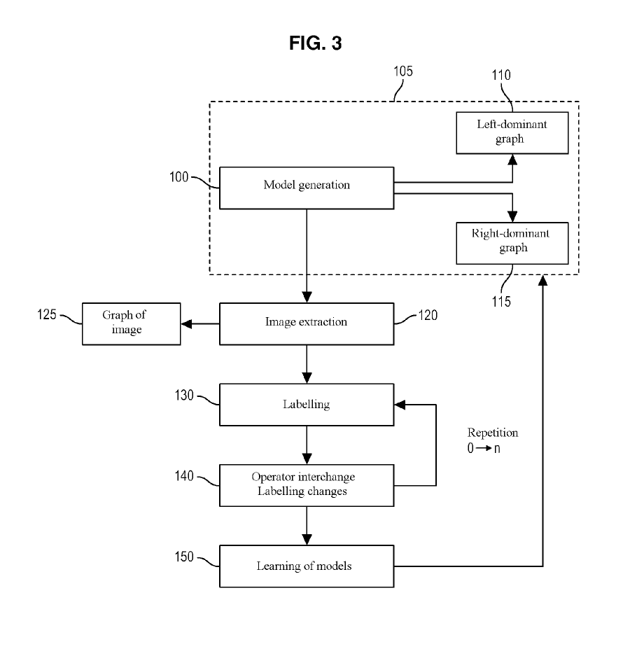

With reference to FIG. 1, the image acquisition system 1 comprises a portal frame 2 consisting of a “third generation” CT scanning module provided with an X-ray source 3 and a row 4 of radiation detectors located on the side opposite the X-ray source 3. With this type of third generation scanner it is possible scan the width of a patient 5 over a depth of 1 to 10 mm (50 cm for the abdomen) with a single X-ray emission. Said patient 5 is placed on a motorized table 6 so that said patient 5 can be moved through the opening 7 of the portal frame 2.

With reference to FIG. 2, the X-ray source 3 projects an X-ray beam 8 towards the row 4 of radiation detectors, said row 4 of detectors consisting of detector elements 9 which detect all the projected X-rays which pass through the patient. The row 4 of detectors may have a single layer configuration i.e. an array of detectors, or a multilayer configuration i.e. a matrix of detectors. Each detector element 9 produces an electric signal which represents the intensity of an X-ray beam striking this detector element 9 and hence the attenuation of the beam as it passes through the patient 5 at a corresponding angle.

During scanning to acquire data by X-ray projection, the portal frame 2 and the parts joined to said portal frame 2 i.e. the X-ray source 3 and the row 4 of radiation detectors are driven in rotation about an axis 10. During this rotation, around 180 to 360 emissions are made and detected in 2 to 7 seconds.

Rotation of the portal frame 2 and the functioning of the X-ray source 3 are piloted by a command device 11 which includes an X-ray controller 12, a portal frame motor controller 13 and a data acquisition system called DAS 14.

In well known manner, the X-ray controller 12 provides power and synchronization signals to the X-ray source 3. The portal frame motor controller 13 commands the speed and rotational position of the portal frame 2. The DAS 14 samples analogue data of the detector elements 9 and converts this data into digital signs for the following processing.

The acquisition system 1 also comprises an image reconstructor 15 which receives the sampled, digitized X-ray data from the DAS 14 and performs fast-rate reconstruction of the image.

The reconstructed image is applied as input to a processing computer 16 which stores the image in a mass memory device 17.

The processing computer 16 is a PC-type computer or of any other processing means such as processors, micro-controllers, micro-computers, programmable logic controllers, application-specific or other integrated circuits, or other devices which include a computer such as a work station.

It is to be noted that the processing computer 16 also receives commands and user scanning parameters via a console 18 which comprises data entry means such as a keypad and/or mouse or similar. Also the acquisition system 1 comprises display means 19 associated with the processing means to enable a user to observe the reconstructed image and other data.

Accessorily, the acquisition system comprises a table motor controller 20 to command the motorized table 6 on which the patient 5 is positioned so that the patient can be moved through the opening of the portal frame.

The processing computer 16 is programmed or is able to run a program recorded on a physical medium 21, which may or may not be removable, to carry out the method to label a vascular tree described below.

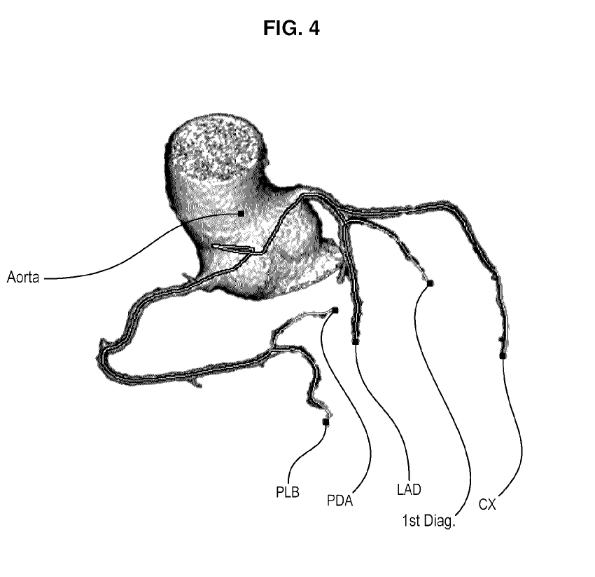

With reference to FIG. 4, one or more images of an organ or group of organs having been previously acquired by a medical imaging device such as described above, said method comprises a first step 100 to generate at least one vascular tree model of a determined organ including a database 105 of labels corresponding to each branch of the vascular tree models. For example, this database 105 comprises a sub-set 110 grouping together all the graph models of right-dominant vascular trees and a second sub-set 115 grouping together all the graph models of left-dominant vascular trees.

The method also comprises a second step 120 to extract the image, comprising a step 125 to determine an acquired vascular tree of the organ or group of organs by segmenting the previously acquired image, and a step 130 to compare the acquired vascular tree with the vascular tree model(s) of the said organ or group of organs to generate labelling of the vascular tree branches.

The acquired vascular tree and the labels corresponding to the modelled vascular tree having the closest similarity with the acquired vascular tree are then displayed on the display 19 of the acquisition system shown FIG. 2.

In particularly advantageous manner, the method of the invention comprises a step 140 for operator modification of at least one label displayed on the display means. For this purpose, the operator may use a console 18 (FIG. 2) or any other equivalent means.

The preceding step 130 is then performed a further time to generate new labels in relation to the modified label(s) and modelled vascular tree.

Next, the acquired tree and corresponding labels thus determined, are again displayed.

The preceding steps 130 and 140 of modification by an operator of at least one displayed label, determination of the other displayed labels in relation to the modified label(s) and modelled vascular tree, and display of the acquired tree and of corresponding labels thus determined, are repeated n times until the displayed vascular tree conforms to operator requirements.

Advantageously, the displayed vascular tree and corresponding labels are recorded in the database 105 of models during a model learning step 150. In this way, the model database can be enriched with a new model more representative of the different anatomical variations encountered. For a given organ, the heart for example, there are effectively a large number of anatomical variations from one patient to another. For example in a children's hospital, the acquisition system can provide labelling of the different branches of the vascular tree adapted to the anatomy of children, in a swifter, more efficient manner.

An example of the vascular tree of a human heart determined using the method of the invention is illustrated FIG. 4.

The method of the invention can be applied to all the organs or groups of organs of a human or animal body without departing from the scope of the invention.

This model learning step 150 preferably comprises a learning step of neural network type such as a neural network from the following non-exhaustive list: Adaline (ADAptive LInear NEuron), Adaptive Heuristic Critic (AHC), Time Delay Neural Network (TDNN), Associative Reward Penalty (ARP), Avalanche Matched Filter (AMF), Backpercolation (Perc), Artmap, Adaptive Logic Network (ALN), Cascade Correlation (CasCor), Extended Kalman Filter (EKF), Learning Vector Quantization (LVQ), Probabilistic Neural Network (PNN), General Regression Neural Network (GRNN), Brain-State-in-a-Box (BSB), Fuzzy Cognitive Map (FCM), Boltzmann Machine (BM), Mean Field Annealing (MFT),

Recurrent Cascade Correlation (RCC), Backpropagation through time (BPTT), Real-time recurrent learning (RTRL), Recurrent Extended Kalman Filter (EKF), Additive Grossberg (AG), Shunting Grossberg (SG), Binary Adaptive Resonance Theory (ART1), Analog Adaptive Resonance Theory (ART2, ART2a), Discrete Hopfield (DH), Continuous Hopfield (CH), Discrete Bidirectional Associative Memory (BAM), Temporal Associative Memory (TAM), Adaptive Bidirectional Associative Memory (ABAM), etc. . . . or any other learning step known per se.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiments disclosed for carrying out this invention, but that the invention includes all embodiments falling with the scope of the appended claims. Moreover, the use of the terms first, second, etc. does not denote any order of importance, but rather the terms first, second, etc. are used to distinguish one element from another.

What is claimed is:

1. A method of labelling a vascular tree from an image of an organ or group of organs acquired by a medical imaging device, the method comprising:
generating at least one vascular tree model of a determined organ including a database of labels corresponding to each branch of the vascular tree models;
determining a vascular tree of the organ or group of organs by segmenting the previously acquired image;
comparing the acquired vascular tree with the vascular tree model(s) of said organ or group of organs; and
displaying the acquired vascular tree and the labels corresponding to the modelled vascular tree having the closest similarity with the acquired vascular tree.

2. The method of claim 1, comprising:
receiving input from an operator that modifies at least one displayed label;
determining the other displayed labels in relation to the modified label(s) and modelled vascular tree; and
displaying the acquired tree and of the corresponding labels thus determined.

3. The method of claim 2, the method further comprising:
the displayed vascular tree and the corresponding labels are recorded in the database of models.

4. A device to label a vascular tree controlling a medical imaging device, the device comprising:
a processor;
a memory coupled to said processor;
a database containing vascular tree models of a determined organ including a database of labels corresponding to each branch of the vascular tree models stored in said memory;
wherein said processor is configured to determine an acquired vascular tree of the organ or group of organs by, acquiring an image of the organ or group of organs from said medical imaging device, segmenting said image of the organ or group of organs previously acquired by the medical imaging device, comparing the acquired vascular tree with the vascular tree model(s) of said organ or group of organs, and outputting the acquired vascular tree and the labels corresponding to the vascular tree model having the closest similarity with the acquired vascular tree.

5. The device of claim 4, the device further comprising:
said processor configured to enable an operator to modify at least one of the displayed labels, determining the other displayed labels in relation to the modified label(s) and modelled vascular tree, and displaying the acquired tree and corresponding labels thus determined.

6. The device of claim 5, the device further comprising:
characterized in that it comprises a device to record the displayed vascular tree and corresponding labels in the database of models.

8. A computer readable medium comprising executable instructions adapted to perform the method of claim 1.

9. The computer readable medium comprising executable instructions of claim 8, further comprising:
receiving input from an operator that modifies at least one displayed label;
determining the other displayed labels in relation to the modified label(s) and modelled vascular tree; and
displaying the acquired tree and of the corresponding labels thus determined.

10. The computer readable medium comprising executable instructions of claim 9, further comprising:
recording the displayed vascular tree and corresponding labels in the database of models.
